(19) United States
(12) Patent Application Publication
(10) Pub. No.: US 2017/0016270 A1
(43) Pub. Date: Jan. 19, 2017

(54) METHOD OF PRODUCING VACUUM SEALED COMPONENT

(71) Applicant: Asahi Glass Company, Limited, Chiyoda-ku (JP)

(72) Inventors: Noriyoshi KAYABA, Chiyoda-ku (JP); Masahide KOGA, Chiyoda-ku (JP); Yohei NAGAO, Chiyoda-ku (JP)

(73) Assignee: Asahi Glass Company, Limited, Chiyoda-ku (JP)

(21) Appl. No.: 15/190,972

(22) Filed: Jun. 23, 2016

(30) Foreign Application Priority Data
Jul. 13, 2015 (JP) 2015-139670

(51) Int. Cl. E06B 3/677; E06B 3/663; B32B 17/06; C03B 29/16; B32B 7/14

(52) U.S. Cl. CPC E06B 3/677; C03B 29/16; B32B 7/14; B32B 17/06; E06B 3/66304; B32B 2250/02; B32B 2255/20; B32B 2305/80; B32B 2307/304; B32B 2419/00

(57) ABSTRACT

There is provided a method of producing a vacuum sealed component including a sealing layer formed by heating glass powder, an inner side of the sealing layer including a closed space with specific air pressure that is lower than atmospheric pressure. The method includes a binder removal process of decomposing an organic binder by heating paste including the glass power and an organic binder; and a vacuum sintering process of forming the closed space by melting, at a temperature that is higher than a processing temperature of the binder removal process, the glass powder in a decompressed space with the specific air pressure that is lower than the atmospheric pressure. After the binder removal process and prior to the vacuum sintering process, an amount of residual carbon in a residue of the paste is less than or equal to 100 ppm by weight.

### CROSS-REFERENCE TO RELATED APPLICATION

The present application is based on and claims the benefit of priority of Japanese Priority Application No. 2015-139670 filed on Jul. 13, 2015, the entire contents of which are hereby incorporated by reference.

### BACKGROUND OF THE INVENTION

1. Field of the Invention

The present invention relates to a method of producing a vacuum sealed component.

2. Description of the Related Art

A vacuum multi-layer glass, as an example of a vacuum sealed component, includes a first glass plate; a second glass plate; and a closed space formed between the first glass plate and the second glass plate. The closed space is a space with specific air pressure that is lower than the atmospheric pressure. The vacuum multi-layer glass is superior in a heat insulating property, so that the vacuum multi-layer glass can be used, for example, as a window glass for buildings.

A method of producing a vacuum multi-layer glass includes a process of sealing a periphery of the first glass plate and the second glass plate with a seal material; a process of attaching a glass tube to a stepped hole of the first glass plate, and vacuum drawing the glass tube; and a step of melting an end portion of the glass tube so as to close the end portion (cf. Patent Document 1, for example).

As another method of producing a vacuum multi-layer glass, there is a method in which an assembly including a first glass plate, a second glass plate, and a seal material is carried in a furnace; and both bonding and sealing are performed in a decompressed space in the furnace (cf. Patent Document 2, for example). According to this method, for example, a glass tube is not required.

### [Patent Document]

[Patent Document 1] Japanese Unexamined Patent Publication No. H10-2161
[Patent Document 2] Japanese Unexamined Patent Publication No. 2014-80313

As a seal material of the vacuum sealed component, paste including glass powder and an organic binder is used.

When thermal processing is applied to the paste in a decompressed space, air bubbles may be generated, so that airtightness may not be ensured.

There is a need for a method of producing a vacuum sealed component such that, even if thermal processing is applied to paste in a decompressed space, airtightness can be ensured.

### SUMMARY OF THE INVENTION

According to an aspect of the present invention, there is provided a method of producing a vacuum sealed component including a sealing layer that is formed by applying thermal processing to glass powder, an inner side of the sealing layer including a closed space with specific air pressure that is lower than atmospheric pressure. The method includes a binder removal process of decomposing an organic binder by heating paste including the glass power and the organic binder; and a vacuum sintering process of forming, after the binder removal process, the closed space by melting, at a temperature that is higher than a processing temperature of the binder removal process, the glass powder in a decompressed space with the specific air pressure that is lower than the atmospheric pressure, wherein after the binder removal process and prior to the vacuum sintering process, an amount of residual carbon in a residue of the paste is less than or equal to 100 ppm by weight.

According to an embodiment of the present invention, a method of producing a vacuum sealed component is provided such that, even if thermal processing is applied to paste in a decompressed space, airtightness can be ensured.

### BRIEF DESCRIPTION OF THE DRAWINGS

Other objects, features and advantages of the present invention will become more apparent from the following detailed description when read in conjunction with the accompanying drawings.

FIG. 1 is a flowchart illustrating a method of producing a vacuum multi-layer glass according to an embodiment;

FIG. 2 is a cross-sectional view illustrating an assembling process according to the embodiment;

FIG. 3 is a cross-sectional view illustrating a vacuum sintering process according to the embodiment;

FIG. 4 is a cross-sectional view illustrating the vacuum multi-layer glass according to the embodiment;

FIG. 5 is a diagram schematically illustrating an image of an X-ray passing through a sealing layer in a thickness direction of the sealing layer (the vertical direction in FIG. 4); and

FIG. 6 is a cross-sectional view illustrating the vacuum multi-layer glass according to another embodiment.

### DETAILED DESCRIPTION OF THE PREFERRED EMBODIMENTS

An embodiment for implementing the present invention is described below by referring to the accompanying drawings. In the drawings, the same or corresponding reference numerals are attached to the same or corresponding components, and thereby the description may be omitted. In the present specification, an expression “x to y” representing a numerical range is defined to be a range including the numerical values “x” and“y.”

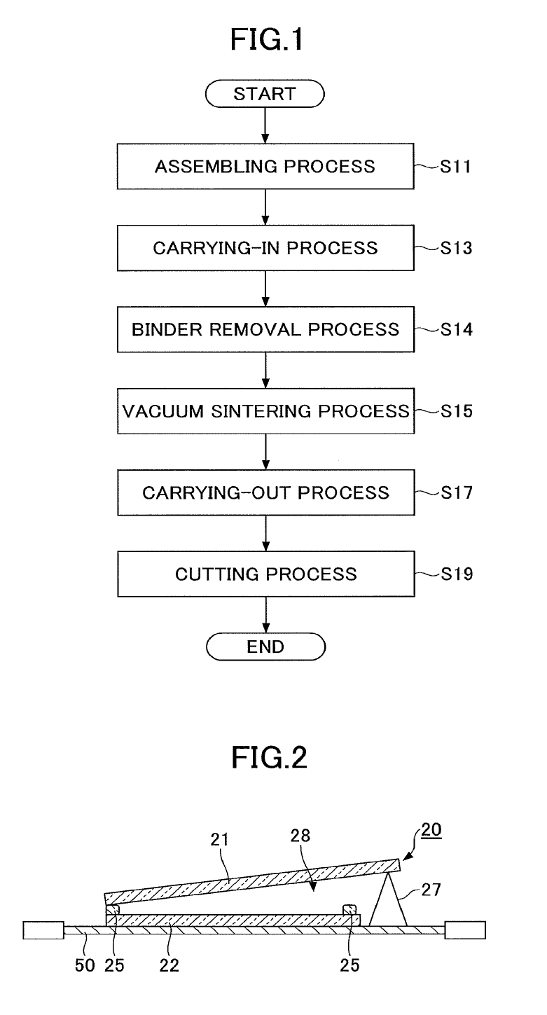

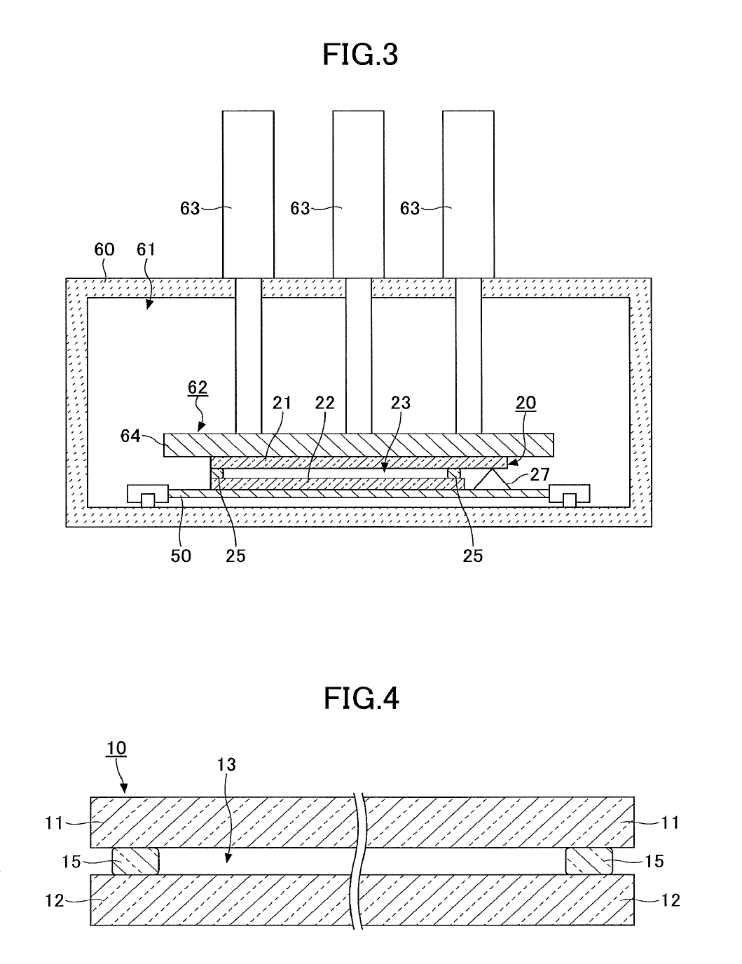

FIG. 1 is a flowchart illustrating a method of producing a vacuum multi-layer glass according to an embodiment. FIG. 2 is a cross-sectional view illustrating an assembling process according to the embodiment. FIG. 3 is a cross-sectional view illustrating a vacuum sintering process according to the embodiment.

As illustrated in FIG. 1, the method of producing the vacuum multi-layer glass includes an assembling process S11; a carrying-in process S13; a binder removal process S14; a vacuum sintering process S15; a carrying-out process S17; and a cutting process S19.

In the assembling process S11, an assembly 20 is assembled, as illustrated in FIG. 2. The assembly 20 includes an upper glass plate 21, as a first glass plate; a lower glass plate 22, as a second glass plate; a sealing material 25; and a degassing spacer 27. The degassing spacer 27 may not be a part of the vacuum multi-layer glass.

The upper glass plate 21 and the lower glass plate 22 may be generic glass plates for buildings. A heat-ray reflection film may be formed on at least one of the upper glass plate 21 and the lower glass plate 22. The heat-ray reflection film may be formed of silver or tin oxide, for example. The heat-ray reflection film is also referred to as a low emissivity (Low-E) film.

The upper glass plate 21 and the lower glass plate 22 are formed of the same type of glass. However, the upper glass plate 21 may be formed of a type of glass that differs from a type of glass of the lower glass plate 22. The size of the upper glass plate 21 may be greater than the size of the lower glass plate 22, so that, when the assembly 20 is viewed from a position above the assembly 20, the upper glass plate 21 may protrude from the lower glass plate 22.

The sealing material 25 is formed to have a frame shape, and the sealing material 25 is placed between the upper glass plate 21 and the lower glass plate 22. The sealing material 25 can be, for example, a material that is obtained by drying paste. The paste is applied, for example, to an upper surface of the lower glass plate 22, and the paste is dried. By sintering the sealing material 25, the sealing layer 15 illustrated in FIG. 4 is formed.

The paste may include, for example, glass powder, an organic binder, and a solvent.

The material of the glass powder is not particularly limited. However, from a viewpoint of reducing burden on the environment, for example, lead-free glass powder is preferable, and bismuth-based glass powder is particularly preferable. The bismuth-based glass includes, in terms of percentage by mass, 70% to 90% Bi₂O₃; 1% to 20% ZnO; 2% to 12% B₂O₃; 0.1% to 5% Al₂O₃; 0.1% to 5% CeO₂; 0% to 5% CuO; 0.01% to 0.2% Fe₂O₃; and 0.05% to 5% CuO and Fe₂O₃ in total, and a total amount of alkali metal oxides, such as Li₂O, Na₂O, and K₂O, is less than 0.1%, for example. Note that, instead of the bismuth-based glass, a lead-containing glass may be used.

A 50% particle diameter D50 of the glass powder is, for example, from 1 μm to 20 μm; and the 50% particle diameter D50 is preferably from 3 μm to 10 μm. A 50% particle diameter D50 is a particle diameter corresponding to an accumulated amount of 50% in a cumulative distribution (volume basis) of particle diameters. Namely, a 50% particle diameter D50 is a particle diameter of a particle that is obtained by accumulating volumes of the particles in an ascending order of the particle diameters, and choosing the particle such that the accumulating volume up to the particle corresponds to 50% of the total volume of the all particles. The 50% particle diameter D50 can be measured by a laser diffraction particle size distribution measurement device.

A 90% particle diameter D90 is, for example, from 5 μm to 50 μm; and the 90% particle diameter D90 is preferably from 10 μm to 20 μm. A 90% particle diameter D90 is a particle diameter corresponding to an accumulated amount of 90% in the cumulative distribution (volume basis) of the particle diameters. Namely, a 90% particle diameter D90 is a particle diameter of a particle that is obtained by accumulating the volumes of the particles in the ascending order of the particle diameters, and choosing the particle such that the accumulating volume up to the particle corresponds to 90% of the total volume of the all particles. The 90% particle diameter D90 can be measured by the laser diffraction particle size distribution measurement device.

The organic binder is for binding the glass powder after the glass powder is dried. After binding the glass powder, the organic binder is removed by thermal processing. The material of the organic binder is not particularly limited. However, ethyl cellulose or polypropylene carbonate can be used as the material of the organic binder, for example.

The solvent is for dissolving the organic binder. The solvent is selected depending on a type of the organic binder. The solvent is removed by thermal processing, such as drying.

The glass of the glass powder included in the sealing material 25 has a melting point that is lower than the melting point of the upper glass plate 21 and the lower glass plate 22, so that the glass of the glass powder included in the sealing material 25 has a linear expansion coefficient that is greater than the linear expansion coefficient of the upper glass plate 21 and the lower glass plate 22. In this specification, the “linear expansion coefficient” means an average linear expansion coefficient from 30° C. to 300° C.

In this case, in addition to the glass powder, the organic binder, and the solvent, the sealing material 25 may include a low thermal expansion powder. The low thermal expansion powder has a linear expansion coefficient that is less than the linear expansion coefficient of the upper glass plate 21 and the lower glass plate 22. A difference between the thermal expansion of the upper glass plate 21 and the lower glass plate 22 and the thermal expansion of the sealing layer 15 that is formed by sintering the sealing material 25 can be reduced.

The low thermal expansion powder includes one or more types of powder that are selected from a group formed of zircon, cordierite, aluminum titanate, alumina, mullite, silica, tin oxide-based ceramic, β-eucryptite, β-spodumene, phosphate zirconium-based ceramics, and β-quartz solid solution. A type of the low thermal expansion powder may be selected depending on a type of the glass of the glass powder. For a case where the glass of the glass powder is a bismuth-based glass, cordierite is particularly preferable as the material of the low thermal expansion powder.

The low thermal expansion powder has a melting point that is higher than the processing temperature of the vacuum sintering process S15. Thus, from the view point of fluidity of the sealing material 25 in the vacuum sintering process S15, the total volume of the low thermal expansion powder is preferably less than or equal to 50% of the total volume of the mixture of the low thermal expansion powder and the glass powder. The total volume of the low thermal expansion powder can be calculated by dividing a total mass of the low thermal expansion powder by the density of the low thermal expansion powder. Similarly, the total volume of the glass powder can be calculated by dividing a total mass of the glass powder by the density of the glass powder.

The 50% particle diameter D50 of the low thermal expansion powder is, for example, from 1 μm to 20 μm; and the 50% particle diameter D50 of the low thermal expansion powder is preferably from 3 μm to 10 μm.

The 90% particle diameter D90 of the low thermal expansion powder is, for example, from 1 μm to 100 μm; and the 90% particle diameter D90 of the low thermal expansion powder is preferably from 3 μm to 50 μm. The degassing spacer 27 is placed, for example, on the conveyance stand 50. The degassing spacer 27 supports the upper glass plate 21 so as to form a gap 28 between the upper glass plate 21 and the sealing material 25. As illustrated in FIG. 2, it suffices if the gap 28 is formed at least at a part of the sealing material 25. The gap 28 may not be formed over the whole sealing member 25.

The degassing spacer 27 supports the portion of the upper glass plate 21 that protrudes, when the assembly 20 is viewed from a position above the assembly 20, from the lower glass plate 22; and the degassing spacer 27 causes the upper glass plate 21 to be inclined with respect to the lower glass plate 22. Here, the degassing spacer 27 may support the upper glass plate 21 so that the upper glass plate 21 is parallel to the lower glass plate 22.

The degassing spacer 27 may be configured so that the height of the degassing spacer 27 may be varied, as pressure is applied to the degassing spacer 27. For example, the degassing spacer 27 may be a metal piece having a cross-sectional shape (an inverted V-shape in FIG. 2) that can be collapsed, upon pressure being applied. The cross-sectional shape of the metal piece may be a wave-like shape, and the cross-sectional shape of the metal piece is not particularly limited.

Note that the degassing spacer 27 may be a glass piece. The glass piece can be melted at a temperature that is lower than a melting temperature of the metal piece, and the glass piece is collapsed, as pressure is applied. Alternatively, the degassing spacer 27 may be an elastic body, such as a spring.

In the carrying-in process S13, the conveyance stand 50 for conveying the assembly 20 is carried in the furnace. The conveyance stand 50 may be carried inside the furnace from an entrance of the furnace; and the conveyance stand 50 may be carried out from an exit of the furnace through a plurality of zones inside the furnace. As the conveyance stand 50 moves inside the furnace, the binder removal process S14, the vacuum sintering process S15, and so forth are applied.

In the binder removal process S14, thermal processing is applied to the assembly 20 to decompose the organic binder included in the paste. Decomposition of the organic binder may be processed, for example, in an atmospheric environment or in an oxygen environment to promote the reaction. After the binder removal process S14, the vacuum sintering process S15 is applied.

As illustrated in FIG. 3, in the vacuum sintering process S15, the assembly 20 is heated, in a decompressed space 61 of the furnace 60, at a temperature that is higher than the processing temperature of the binder removal process S14, so as to melt the glass powder included in the sealing material 25.

The air pressure in the decompressed space 61 is lower than the atmospheric pressure. The air pressure in the decompressed space 61 may be from 1×10⁻⁵ Pa to 10 Pa; and the air pressure in the decompressed space 61 may preferably be from 1×10⁻⁵ Pa to 0.1 Pa.

After melting the sealing material 25, the conveyance stand 50 and a pressure application member 62 placed above the conveyance stand 50 apply pressure to the assembly 20 in the decompressed space 61 of the furnace 60. The pressure application member 62 is formed of, for example, a plurality of hydraulic cylinders 63; and a pressure application plate 64. A main body of each hydraulic cylinder 63 is fixed to a ceiling of the furnace 60, and a tip of a rod of each hydraulic cylinder 63 is fixed to the pressure application plate 64. The pressure application plate 64 can be vertically moved with respect to the conveyance stand 50.

The hydraulic cylinders 63 move the pressure application plate 64 downward, so that the assembly 20 is pinched between the pressure application plate 64 and the conveyance stand 50 to apply pressure to the assembly 20. Consequently, the height of the degassing spacer 27 is contracted, and the gap 28 that is formed by the degassing spacer 27 is removed. Then, both upper glass plate 21 and lower glass plate 22 adhere to the sealing material 25 to form a closed space 23 between the upper glass plate 21 and the lower glass plate 22. The closed space 23 is a space with specific air pressure that is lower than the atmospheric pressure.

Subsequently, while the pressure is applied to the assembly 20 by the pressure application plate 64 and the conveyance stand 50 in the decompressed space 61 of the furnace 60, the sealing material 25 is cooled and solidified. In this manner, the upper glass plate 21 and the lower glass plate 22 are bonded by the sealing material 25, and thereby the closed space 23 that is formed between the upper glass plate 21 and the lower glass plate 22 is sealed.

After that, the hydraulic cylinders 63 move the pressure application plate 64 upward to release application of the pressure to the assembly 20. In the embodiment, the release timing is after the sealing material 25 is cooled and solidified. However, the release timing may by any timing, as long as the timing is after both upper glass plate 21 and lower glass plate 22 contact the sealing material 25. Note that, for a case where an elastic body is used as the degassing spacer 27, the above-described release timing is after the sealing material 25 is cooled and solidified.

In the carrying-out process S17, the conveyance stand 50 for conveying the assembly 20 is carried out from the furnace 60. Prior to carrying out the conveyance stand 50 from the furnace 60, the assembly 20 is gradually cooled in the furnace 60.

In the cutting process S19, the assembly 20 carried out from the furnace 60 is cut, thereby obtaining a vacuum multi-layer glass. For example, in the cutting process S19, the portion of the upper glass plate 21 that protrudes, when the assembly 20 is viewed from a position above the assembly 20, from the lower glass plate 22 is cut, and thereby the vacuum multi-layer glass is obtained.

In the cutting process S19, by cutting one assembly 20, a plurality of vacuum multi-layer glasses may be obtained. In this case, each assembly 20 includes a plurality of sealing materials 25, and cutting is made between the sealing materials 25.

The cutting process S19 is an optional process. The cutting process S19 may not be performed.

In the embodiment, the furnace 60 is a continuous type. However, the furnace 60 may be a batch type. For a case where the furnace 60 is a batch type, after the binder removal process S14 and prior to the vacuum sintering process S15, the assembly 20 may be removed temporarily from the furnace 60. In this case, in the assembly 20, only the lower glass plate 22 and the sealing material 25 may be provided to apply the binder removal process S14. In this case, the upper glass plate 21 may not be provided to apply the binder removal process S14.

In the embodiment, after the binder removal process S14 and prior to the vacuum sintering process S15, an amount of residual carbon in a residue of the paste is restricted to be less than or equal to 100 ppm by weight. The amount of the residual carbon represents a remaining amount of the organic binder. As the remaining amount of the organic binder is smaller, the amount of the residual carbon becomes smaller.

If, after the binder removal process S14 and prior to the vacuum sintering process S15, the amount of the residual carbon in the residue of the paste is less than or equal to 100 ppm by weight, the remaining amount of the organic binder is sufficiently small, so that formation of air bubbles at the vacuum sintering process S15 can be suppressed. Thus, airtightness of the sealing layer 15 that is formed by sintering the sealing material 25 is favorable. After the binder removal process S14 and prior to the vacuum sintering process S15, the amount of residual carbon in the residue of the paste is preferably less than or equal to 80 ppm by weight, more preferably less than or equal to 60 ppm by weight.

After the binder removal process S14 and prior to the vacuum sintering process S15, the amount of residual carbon in the residue of the paste can be adjusted, for example, by adjusting the processing temperature, the processing time, and the processing environment of the binder removal process S14. In the binder removal process S14, the paste is heated, for example, at a temperature from 350° C. to 450° C., and for a time period from 20 minutes to one hour.

In the vacuum sintering process 15, the glass powder is melted at a temperature that is higher than the processing temperature of the binder removal process S14. In the vacuum sintering process, the paste is heated, for example, at a temperature from 450° C. to 560° C., and for a time period from 20 minutes to one hour. Note that the organic binder is also decomposed at the vacuum sintering process.

FIG. 4 is a cross-sectional view illustrating the vacuum multi-layer glass according to the embodiment. The vacuum multi-layer glass 10 illustrated in FIG. 4 is produced by the producing method illustrated in FIGS. 1 to 3. The vacuum multi-layer glass 10 includes the first glass plate 11; the second glass plate 12; the closed space 13; and the sealing layer 15. Here, a gap reserving spacer may be provided between the first glass plate 11 and the second glass plate 12, which is for reserving a gap between the first glass plate 12 and the second glass plate 12.

The first glass plate 11 and the second glass plate 12 may be generic glass plate for buildings. A heat-ray reflection film may be formed on at least one of the first glass plate 11 and the second glass plate 12. The heat-ray reflection film may be formed of silver or tin oxide, for example. The heat-ray reflection film is also referred to as a low emissivity (Low-E) film.

The first glass plate 11 and the second glass plate 12 are formed of the same type of glass. However, the first glass plate 11 may be formed of a type of glass that differs from a type of glass of the second glass plate 12. The size of the first glass plate 11 is the same as the size of the second glass plate 12. However, the size of the first glass plate 11 may differ from the size of the second glass plate 12. The closed space 13 is formed between the first glass plate 11 and the second glass plate 12.

The sealing layer 15 bonds the first glass plate 11 and the second glass plate 12 while forming a gap between the first glass plate 11 and the second glass plate 12. At the same time, the sealing layer 15 seals the closed space 13. The sealing layer 15 is formed to have a frame-like shape along an outer edge of the first glass plate 11 or an outer edge of the second glass plate 12; and the sealing layer 15 surrounds the closed space 13. The closed space 13 is a space with an air pressure that is lower than the atmospheric pressure. The air pressure of the closed space 13 is, for example, from 0.001 Pa to 0.2 Pa.

The sealing layer 15 is formed by sintering the sealing material 25. According to the embodiment, after the binder removal process S14 and prior to the vacuum sintering process S15, the amount of the residual carbon in the residue of the paste is restricted to be less than or equal to 100 ppm by weight. Consequently, the sealing layer 15 with favorable airtightness can be obtained, which includes fewer air bubbles.

FIG. 5 is a diagram schematically illustrating an image of an X-ray passing through the sealing layer 15 in the thickness direction of the sealing layer 15 (the vertical direction in FIG. 4). The width W of the sealing layer 15 at any position is within a range from 75% to 125% of the average value Wₐᵥₑ of the width W, so that the width W of of the sealing layer 15 is approximately constant. In this case, a ratio P of the air bubbles 15a in the sealing layer 15 at any position, when the ratio P is measured by image processing an image, in the image illustrated in FIG. 5, of an interval having a length that is four times the average value Wₐᵥₑ of the width W in the direction in which the sealing layer 15 is extended, is, for example, less than or equal to 12%, preferably less than or equal to 10%, and more preferably less than or equal to 8%. Since the ratio P of the air bubbles 15a in the sealing layer 15 at any position is less than or equal to 12%, the airtightness is favorable. Note that the width of the above-described interval is the maximum value of the width of the sealing layer 15 in the above-described interval.

In the above-described interval in which the above-described ratio P becomes the maximum, at a position at which the above-described width becomes the maximum, the sealing layer 15 is equally divided into three pieces in the width direction. In this manner, three rectangular regions L, C, and R are formed. Then, for each of the three rectangular regions L, C, and R, the ratio of the air bubbles in the sealing layer 15 is measured. A distribution of the air bubbles in the width direction of the sealing layer 15 is represented by ratios among the measured values. Specifically, the distribution of the air bubbles in the width direction of the sealing layer 15 is represented by the ratio P2/P1, where P1 is the maximum value between the measured values of the rectangular regions L and R at both edges, and P2 is the measured value of the rectangular region C in the middle. If the ratio P2/P1 is less than or equal to 0.9, there are less air bubbles in the center portion in the width direction of the sealing layer 15. Thus, crossing, by the air bubbles 15a, of the sealing layer 15 can be suppressed, so that the airtightness is favorable. The ratio P2/P1 is preferably less than or equal to 0.8, more preferably less than or equal to 0.7.

The amount of residual carbon in the sealing layer 15 is, for example, less than or equal to 50 ppm by weight. Since the organic binder is decomposed in the vacuum sintering process S15, if, after the binder removal process S14 and prior to the vacuum sintering process S15, the amount of the residual carbon in the residue of the paste is restricted to be less than or equal to 100 ppm by weight, the amount of residual carbon in the sealing layer 15 becomes less than or equal to 50 ppm by weight. The amount of residual carbon in the sealing layer 15 is preferably less than or equal to 40 ppm by weight, more preferably less than or equal to 30 ppm by weight.

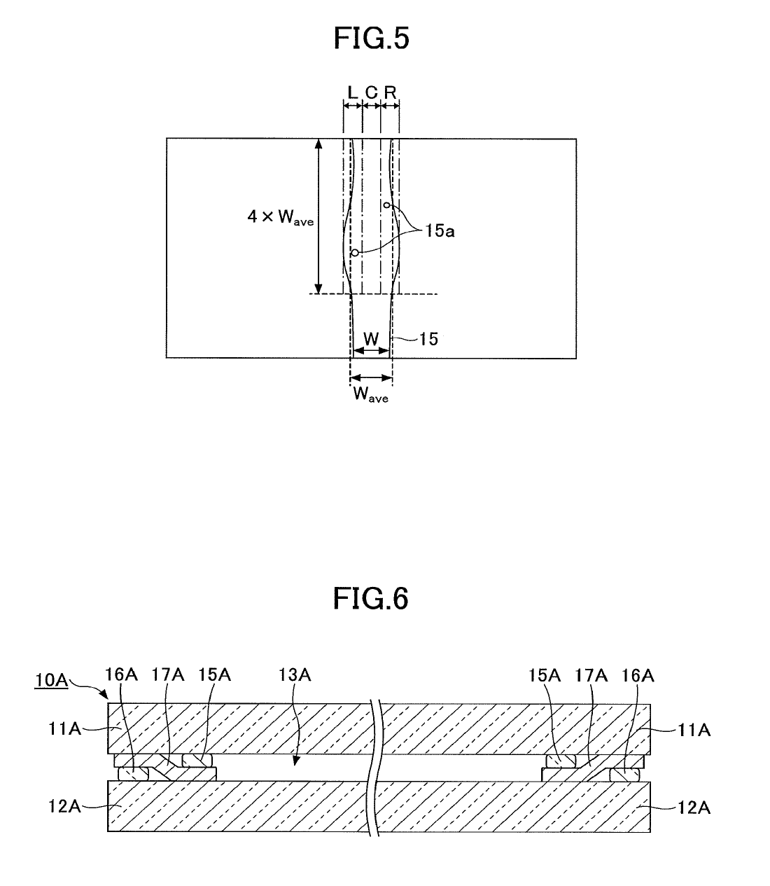

FIG. 6 is a cross-sectional view illustrating the vacuum multi-layer glass according to another embodiment. The vacuum multi-layer glass 10A includes the first glass plate 11A; the second glass plate 12A; the closed space 13A; a first sealing layer 15A; a second sealing layer 16A; and a metal element 17A.

The vacuum multi-layer glass 10A illustrated in FIG. 6 differs from the vacuum multi-layer glass 10 illustrated in FIG. 4 in a point that the vacuum multi-layer glass 10A illustrated in FIG. 6 has a thermal stress relaxation structure. In the following, the difference is mainly described.

Similar to the sealing layer 15 illustrated in FIG. 4, the first sealing layer 15A and the second sealing layer 16A are formed by applying thermal processing to the paste including the glass powder.

The first sealing layer 15A is formed to have a frame-like shape along the outer edge of the first glass plate 11A; and the first sealing layer 15A bonds the first glass plate 11A and the metal element 17A. The first sealing layer 15A does not contact the second glass plate 12A; and the first sealing layer 15A is not bonded to the second glass plate 12A.

The second sealing layer 16A is formed to have a frame-like shape along the outer edge of the second glass plate 12A; and the second sealing layer 16A bonds the second glass plate 12A and the metal element 17A. The second sealing layer 16A does not contact the first glass plate 11A; and the second sealing layer 16A is not bonded to the first glass plate 11A.

As illustrated in FIG. 6, the metal element 17A has a step. The metal element 17A movably contacts the first glass plate 11A, and at the same time, the metal element 17A movably contacts the second glass plate 12A. Note that the metal element 17A may be formed to be flat, and the metal element 17A may not contact the first glass plate 11A and the second glass plate 12A. The cross-section of the metal element 17A may include a straight-line shaped portion and a curved-line shaped portion.

The metal element 17A includes, between the portion bonded to the first sealing layer 15A and the portion bonded to the second sealing layer 16A, a portion that can be elastically deformed. Consequently, thermal stress caused by a temperature difference between the first glass plate 11A and the second glass plate 12A can be absorbed by elastic deformation of the metal element 17A, so that the vacuum multi-layer glass 10A can be prevented from being damaged.

The metal element 17A may be a metal foil. The metal element 17A may be processed to have a wave-like shape, or the metal element 17A may be embossed.

The metal of the metal element 17A is not particularly limited; however, the metal of the metal element 17A may be, for example, aluminum or an aluminum alloy. In this case, from the viewpoint of adhesiveness, the glass of the first sealing layer 15A and the glass of the second sealing layer 16A may preferably be a bismuth-based glass.

Similar to the vacuum multi-layer glass 10 illustrated in FIG. 4, the vacuum multi-layer glass 10A illustrated in FIG. 6 may be produced by the producing method illustrated in FIGS. 1 to 3. Thus, similar to the above-described embodiment, the first sealing layer 15A and the second sealing layer 16A with favorable airtightness can be obtained.

### EXAMPLES

In examples 1 to 8, two types of pastes A and B were prepared; thermal processing was applied to the pastes A and B under the conditions shown in Table 1; the amount of the residual carbon after the thermal processing was measured; and the structure and airtightness of the sealing layer formed by the thermal processing were examined. In examples 1 to 8, the conditions other than the conditions shown in Table 1 (the type of the paste and the condition of the thermal processing) were the same. Examples 1 to 7 were according to the embodiment, and example 8 was the comparative example.

<Pate>

As the paste A, a mixture was prepared, which was obtained by mixing, in predetermined compounding ratios, bismuth-based glass powder; cordierite powder as the low thermal expansion powder; polypropylene carbonate as the organic binder; and propylene glycol diacetate (PGDA) as the solvent. The compounding ratios of the paste A were as follows: 74.6 wt % bismuth-based glass powder; 8.9 wt % cordierite powder; 1.7 wt % polypropylene carbonate; and 14.8 wt % PGDA. The total volume of the cordierite powder was 31% of the total volume of the mixture of the cordierite powder and the bismuth-based glass powder.

As the paste B, a mixture was prepared, which was obtained by mixing, in predetermined compounding ratios, bismuth-based glass powder; cordierite powder as the low thermal expansion powder; ethyl cellulose as the organic binder; and butyl carbitol acetate (BCA) as the solvent. The compounding ratios of the paste B were as follows: 78.7 wt % bismuth-based glass powder; 9.4 wt % cordierite powder; 0.4 wt % ethyl cellulose; and 11.5 wt % BCA. The total volume of the cordierite powder was 31% of the total volume of the mixture of the cordierite powder and the bismuth-based glass powder.

The same bismuth-based glass powder was used as the bismuth-based glass powder included in the paste A and the bismuth-based glass powder included in the paste B. The bismuth-based glass powder includes, in terms of mass %, 82.8% Bi₂O₃; 10.7% ZnO; 5.6% B₂O₃; 0.5% Al₂O₃; 0.2% CeO₂:0.1% CuO; and 0.1% Fe₂O₃ (i.e., 0.2% of CuO and Fe₂O₃ in total), and the total amount of alkali metal oxides, such as Li₂O, Na₂O, and K₂O, was less than 0.1%. For this bismuth-based glass powder, the 50% particle diameter D50 was 5 μm, and the 90% particle diameter D90 was 12 μm.

<Amount of Residual Carbon>

A measurement sample for measuring an amount of residual carbon was produced on a polyethylene terephthalate film (PET film) by screen printing the paste on the PET film and drying the paste to volatilize the solvent.

After peeling off the measurement sample from the PET film, the measurement sample was placed in a crucible, and two types of thermal processing, A and B, were applied. The thermal processing A only included the binder removal process, and the thermal processing A did not include the vacuum sintering process. Whereas, the thermal processing B included both binder removal process and subsequent vacuum sintering process. In both thermal processing A and B, the binder removal process was executed in an oxygen atmosphere.

An amount of residual carbon in a residue of the measurement sample to which the thermal processing A was applied and an amount of residual carbon in a residue of the measurement sample to which the thermal processing B was applied were measured by a carbon-sulfur analyzer (product name: EMIA-320V, produced by HORIBA, Ltd.).

<Ratio of Air Bubbles in the Sealing Layer>

The paste was spread on an upper surface of a glass plate, and the paste was dried. Subsequently, the binder removal process was applied to the paste. Then, another glass plate was placed on the glass plate on which the paste was spread, and the vacuum sintering process was applied. In this manner, the sealing layer was produced. As a result, a vacuum multi-layer glass was produced in which the glass plates were bonded by the sealing layer while reserving a gap between the glass plates.

The ratio P of the air bubbles in the sealing layer was measured by using an image of an X-ray passing through the sealing layer in the thickness direction of the sealing layer. Images of the X-ray were captured over the entire periphery of the sealing layer, and the average value of the width W of the sealing layer was measured. Additionally, by image processing an image of an interval having a length that was four times the average value Wₐᵥₑ of the width W in the direction in which the sealing layer was extended, the maximum value of the ratio P was measured.

<Distribution of the Air Bubbles in the Width Direction of the Sealing Layer>

In the above-described interval in which the above-described ratio P was the maximum, at a position at which the above-described width was the maximum, the sealing layer 15 was equally divided into three pieces in the width direction. In this manner, three rectangular regions L, C, and R were formed. Then, for each of the three rectangular regions L, C, and R, the ratio of the air bubbles in the sealing layer 15 was measured. A distribution of the air bubbles in the width direction of the sealing layer 15 was represented by ratios among the measured values. Specifically, the distribution of the bubbles in the width direction of the sealing layer 15 was represented by the ratio P2/P1, where P1 was the maximum value between the measured values of the rectangular regions L and R at both edges, and P2 was the measured value of the rectangular region C in the middle.

<Airtightness of the Sealing Layer>

The airtightness of the sealing layer was evaluated by a helium leak test of the vacuum multi-layer glass. For the helium leak test, the helium leak detector, HELIOT712D2 (produced by ULVAC, Inc.), was used. In the vacuum multi-layer glass that was used for the measurement, a screw hole was formed by using a drilling machine on a surface of one of the glass plates at a position inside the sealed portion. The diameter of the screw hole was 4 mm, and the depth of the screw hole was greater than a half of the thickness of the glass plate. The screw hole did not pass through the glass plate. After wiping the cutting water, the hole was further extended by using a hand grinder, so that the hole reached inside the closed space. The helium leak detector was connected to this hole, and helium gas was sprayed onto the sealed portion of the vacuum multi-layer glass. At this time, if the value indicated by the helium leak detector did not change with respect to a value for a case where no gas was sprayed onto the sealed portion, the vacuum multi-layer glass was evaluated to be “good.” Whereas, if the value indicated by the helium leak detector was increased, the vacuum multi-layer glass was evaluated to be “poor.”

<Results>

Table 1 shows a type of the paste and a condition of sintering the paste; an amount of residual carbon in a residue of the paste after the binder removal process and prior to the vacuum sintering process; an amount of residual carbon in the sealing layer after the vacuum sintering process; a ratio of air bubbles in the sealing layer; a result of evaluation of the airtightness, and so forth.

TABLE 1

| | Ex. 1 | Ex. 2 | Ex. 3 | Ex. 4 | Ex. 5 | Ex. 6 | Ex. 7 | Ex. 8 |
|---|---|---|---|---|---|---|---|---|
| Type of | Paste A | Paste B | Paste B | Paste B | Paste B | Paste A | Paste B | Paste B |
| paste | | | | | | | | |
| Conditions | 420° C. | 420° C. | 420° C. | 420° C. | 420° C. | 350° C. | 350° C. | 300° C. |
| of binder | 30 | 30 | 30 | 30 | 30 | 30 | 30 | 30 |
| removal | minutes | minutes | minutes | minutes | minutes | minutes | minutes | minutes |
| process | | | | | | | | |
| Amount of | 10 | 15 | 15 | 15 | 15 | 16 | 47 | 105 |
| residual | | | | | | | | |
| carbon | | | | | | | | |
| (ppm by | | | | | | | | |
| wt) after | | | | | | | | |
| binder | | | | | | | | |
| removal | | | | | | | | |
| process | | | | | | | | |
| (thermal | | | | | | | | |
| process A) | | | | | | | | |
| Conditions | 490° C. | 490° C. | 460° C. | 460° C. | 460° C. | 460° C. | 460° C. | 460° C. |
| of vacuum | 30 | 30 | 30 | 30 | 30 | 30 | 30 | 30 |
| sintering | minutes | minutes | minutes | minutes | minutes | minutes | minutes | minutes |
| process | | | | | | | | |
| Amount of | 6 | 7 | 13 | 13 | 13 | 9 | 20 | 53 |
| residual | | | | | | | | |
| carbon | | | | | | | | |
| (ppm by | | | | | | | | |
| wt) after | | | | | | | | |
| vacuum | | | | | | | | |
| sintering | | | | | | | | |
| process | | | | | | | | |
| (thermal | | | | | | | | |
| process B) | | | | | | | | |
| Average | 2.39 | 3.32 | 2.60 | 3.26 | 1.53 | 2.22 | 2.33 | 3.07 |
| value of | | | | | | | | |
| the width | | | | | | | | |
| of the | | | | | | | | |
| sealing | | | | | | | | |
| layer (mm) | | | | | | | | |
| Variation | 95-107 | 94-105 | 95-105 | 82-120 | 93-120 | 96-104 | 87-110 | 93-119 |
| of the | | | | | | | | |
| width of | | | | | | | | |
| the | | | | | | | | |
| sealing | | | | | | | | |
| layer (%) | | | | | | | | |
| Maximum | 5.9 | 1.0 | 5.6 | 1.6 | 7.7 | 3.8 | 6.0 | 12.3 |
| value of P | | | | | | | | |
| (%) | | | | | | | | |
| P1 (%) | 5.7 | 3.5 | 8.1 | 2.6 | 15.1 | 11.4 | 13.8 | 17.9 |
| P2 (%) | 4.1 | 0.0 | 0.7 | 1.7 | 8.8 | 1.7 | 4.6 | 20.7 |
| P2/P1 | 0.7 | 0.0 | 0.1 | 0.6 | 0.6 | 0.2 | 0.3 | 1.2 |
| Air- | good | good | good | good | good | good | good | poor |
| tightness | | | | | | | | |

As it can be seen from Table 1, in examples 1 to 7, the amount of the residual carbon in the residue of the paste after the binder removal process and prior to the vacuum sintering process was less than or equal to 100 ppm by weight, the ratio P of the air bubbles in the sealing layer was less than or equal to 12%, and the ratio P2/P1 was less than or equal to 0.9, so that the airtightness of the sealing layer was favorable. Additionally, in examples 1 to 7, the amount of the residual carbon in the sealing layer was less than or equal to 50 ppm by weight. In contrast, in example 8, the amount of the residual carbon in the residue of the paste after the binder removal process and prior to the vacuum sintering process was greater than 100 ppm by weight, the ratio P of the air bubbles in the sealing layer was greater than 12%, and the ratio P2/P1 was greater than 0.9, so that the airtightness of the sealing layer was determined to have failed.

The method of producing the vacuum multi-layer glass, as the vacuum sealed component, is described above by the embodiments. However, the present invention is not limited to the embodiments, and various modifications and improvements may be made within the scope of the gist of the present invention, which is described in the claims.

For example, in the above-described embodiments, the method of producing the vacuum multi-layer glass, as the vacuum sealed component, was described. However, the type of the vacuum sealed component is not particularly limited. As examples of the vacuum sealed component, there are a vacuum fluorescent display (VFD), Micro Electro Mechanical Systems (MEMS), and so forth.

The number and arrangement of the degassing spacer 27 may vary. It suffices if the degassing spacer 27 forms a gap between the sealing material 25 and at least one of the upper glass plate 21 and the lower glass plate 22.

In the above-described embodiments, the height of the degassing spacer 27 is varied upon the pressure being applied. However, the height of the degassing spacer 27 may not be varied. In this case, by changing the position or the orientation of the degassing spacer 27 with respect to the conveyance stand 50, the gap 28 reserved by the degassing spacer 27 can be removed.

The degassing spacer 27 may not be used. For a case where the degassing spacer 27 is not used, the size of the upper glass plate 21 may be the same as the size of the lower glass plate 22, and the cutting process S19 may not be applied.

What is claimed is:

1. A method of producing a vacuum sealed component including a sealing layer that is formed by heating glass powder, an inner side of the sealing layer including a closed space with specific air pressure that is lower than an atmospheric pressure, the method comprising:
a binder removal process of decomposing an organic binder by heating paste including the glass power and an organic binder; and
a vacuum sintering process of forming, after the binder removal process, the closed space by melting, at a temperature that is higher than a processing temperature of the binder removal process, the glass powder in a decompressed space with the specific air pressure that is lower than the atmospheric pressure,
wherein after the binder removal process and prior to the vacuum sintering process, an amount of residual carbon in a residue of the paste is less than or equal to 100 ppm by weight.

2. The method of producing the vacuum sealed component according to claim 1, wherein the paste includes low thermal expansion powder with a melting point that is greater than the processing temperature of the vacuum sintering process and a linear expansion coefficient that is less than a linear expansion coefficient of a member to be bonded by the sealing layer, and
wherein a total volume of the low thermal expansion powder is less than or equal to 50% of a total volume of a mixture of the low thermal expansion powder and the glass powder.

3. The method of producing the vacuum sealed component according to claim 2, wherein the low thermal expansion powder includes one or more types of powder that are selected from a group including zircon, cordierite, aluminum titanate, alumina, mullite, silica, tin oxide-based ceramic, β-eucryptite, β-spodumene, phosphate zirconium-based ceramics, and β-quartz solid solution.

4. The method of producing the vacuum sealed component according to claim 1, wherein the glass powder is a bismuth-based glass powder.

5. The method of producing the vacuum sealed component according to claim 1, wherein, in the binder removal process, the paste is heated at a temperature from 350° C. to 450° C. for a time period from 20 minutes to one hour.

6. The method of producing the vacuum sealed component according to claim 1, wherein, in the vacuum sintering process, the paste is heated at a temperature from 450° C. to 560° C. for a time period from 20 minutes to one hour.

7. The method of producing the vacuum sealed component according to claim 1, wherein the vacuum sealed component is a vacuum multi-layer glass formed by bonding glass plates by the sealing layer while reserving a gap between the glass plates.

8. The method of producing the vacuum sealed component according to claim 1, wherein an amount of residual carbon in the sealing layer of the vacuum sealed component is less than or equal to 50 ppm by weight.

9. The method of producing the vacuum sealed component according to claim 1, wherein the sealing layer of the vacuum sealed component is formed to have a frame-like shape,
wherein a width of the sealing layer, at any position, is in a range from 75% to 125% of an average value of the width, and
wherein, when a ratio of air bubbles in the sealing layer is measured by image processing an image, the image being included in an image of an X-ray passing through the sealing layer in a thickness direction of the sealing layer, of an interval having a length that is four times the average value of the width in a direction in which the sealing layer is extended, the ratio of the air bubbles in the sealing layer at any position is less than or equal to 12%.

10. The method of producing the vacuum sealed component according to claim 1, wherein the sealing layer of the vacuum sealed component is formed to have a frame-like shape,
wherein a width of the sealing layer, at any position, is in a range from 75% to 125% of an average value of the width, and
wherein, when a ratio of air bubbles in the sealing layer is measured by image processing an image, the image being included in an image of an X-ray passing through the sealing layer in a thickness direction of the sealing layer, of an interval having a length that is four times the average value of the width in a direction in which the sealing layer is extended, and when, in the interval in which the ratio is a maximum, the sealing layer is equally divided, at a position at which the width is a maximum, into three pieces to form three rectangular regions, and the ratio of the air bubbles in the sealing layer is measured in each of the three rectangular regions, a ratio P2/P1 is less than or equal to 0.9, wherein P1 is a maximum value between the measured values of the rectangular regions at both edges, and P2 is the measured value of the rectangular region in a middle.
